(19) United States
(12) Patent Application Publication
(10) Pub. No.: US 2007/0172689 A1
(43) Pub. Date: Jul. 26, 2007

(54) Treatment apparatus and method of treating surfaces

(75) Inventors: Robert F. Hoskin, Duluth, GA (US); Kartik Shanker, Winnepeg (CA)

Correspondence Address: TOLER SCHAFFER, LLP, 8500 BLUFFSTONE COVE, SUITE A201, AUSTIN, TX, 78759, US

(73) Assignee: Standard Aero (San Antonio), Inc., San Antonio, TX (US)

(21) Appl. No.: 11/403,698

(22) Filed: Apr. 13, 2006

Related U.S. Application Data
(60) Provisional application No. 60/761,715, filed on Jan. 24, 2006.

(51) Int. Cl. B32B 5/14; C22F 1/16; B32B 7/10

(52) U.S. Cl. 428/610; 148/708; 204/297.03

(57) ABSTRACT

A treatment apparatus includes a vacuum chamber to receive a backfill gas, a support to receive a work piece, a filament located within the vacuum chamber, and an anode located within the vacuum chamber. The support is located within the vacuum chamber.

### CROSS REFERENCE TO RELATED APPLICATION(S)

This application claims priority from U.S. Provisional Patent Application No. 60/761,715, filed Jan. 24, 2006, and entitled “Treatment Apparatus and Method of Treating Surfaces,” which is incorporated herein by reference in its entirety.

### FIELD OF THE DISCLOSURE

This disclosure, in general, relates to systems and methods to treat metallic surfaces.

### BACKGROUND

Industry is turning to mechanical systems to perform ever increasingly demanding tasks. Such demanding tasks increase stress, strain and wear on mechanical system components. In general, improvement in performance of such mechanical systems is limited by materials available for making such components.

Typically, particular components of a mechanical system experience increased physical deterioration relative to other components of the mechanical system. For example, compressor blades of turbine engines experience increased erosion relative to other system components. In particular, the tips, leading edges and trailing edges of compressor blades tend to erode at a more rapid rate than the rest of the compressor blade and other components of a turbine engine. Gears in other mechanical systems experience increased wear relative to other system components. In particular, the teeth of a gear tend to wear at a greater rate than other portions of the gear and other components of the mechanical system that includes the gear.

In an effort to reduce physical deterioration of exposed components, material science has turned to coating methods. Exemplary coatings include silicon-based coatings, carbon based coatings, and ceramic-based coatings. For example, exemplary coatings include a diamond coating, a silicon carbide coating, or a titanium nitride coating. However, such coatings tend to alter the dimensions of precisely machined components. In addition, coatings are difficult to repair and often result in an increased expense to remove the coating and reapply the coating as a whole. Further, once damaged, coatings tend to expose susceptible underlying materials to harsh conditions. Often, coatings result in an abrupt change in material properties at the interface between the component base material and the coating. Such an abrupt change may, for example, result in detachment of a coating, such as in the case of a significant difference in coefficient of thermal expansion. In addition, once a hard coating is damaged, the underlying softer base material is exposed. Without a gradient of protection, the component tends to erode at a greater rate at the point of damage.

More recently, industry has also turned to ion implantation within a component surface to improve material properties. However, improvement in factors such as erosion or wear resistance has been found to be offset by susceptibility to corrosion and fatigue. In particular, nitrided stainless steel may exhibit improved erosion resistance but, may corrode at a faster rate than untreated stainless steel. In a particular example, nitriding of chromium containing alloys at a bulk temperature greater than about 450° C. may result in the formation of surface chromium nitride, which tends to cause increased corrosion susceptibility of the base material. In another example, excessive nitriding of stainless steel alloys reduces fatigue life compared to the untreated material.

As such, an improved system and method to treat components of mechanical systems would be desirable.

### SUMMARY

In a particular embodiment, a treatment apparatus includes a vacuum chamber to receive a backfill gas, a support to receive a work piece, a filament located within the vacuum chamber, and an anode located within the vacuum chamber. The support is located within the vacuum chamber.

In another exemplary embodiment, a method of treating a component includes locating a work piece within a vacuum chamber, negatively electrically biasing the work piece relative to an anode, and heating a filament. The anode and the filament are located within the vacuum chamber.

In a further exemplary embodiment, a component includes a first region formed of a metallic material and having a first functionally gradient surface treatment depth. The component also includes a second region formed of the metallic material and having a second functionally gradient surface treatment depth. The first functionally gradient surface treatment depth is at least 30% greater than the second functionally gradient surface treatment depth. The second functionally gradient surface treatment depth is not greater than 20 micrometers.

In an additional exemplary embodiment, a method of treating a component includes forming a functionally gradient surface in a metallic work piece, and work hardening a portion of the functionally gradient surface using particulate impact.

In a further exemplary embodiment, a method of maintaining a mechanical system includes forming a functionally gradient surface in a component of the mechanical system. The functionally gradient surface includes at least 0.2 wt % nitrogen. The method also includes work-hardening at least a portion of the functionally gradient surface in the component.

### BRIEF DESCRIPTION OF THE DRAWINGS

The present disclosure may be better understood, and its numerous features and advantages made apparent to those skilled in the art by referencing the accompanying drawings.

FIGS. 1A and 1B include illustrations of an exemplary compressor blade for use in a turbine engine system.

FIG. 2 includes an illustration of an exemplary gear for use in a mechanical system.

FIGS. 3 and 4 include illustrations of component surfaces.

FIG. 5 includes a graphical illustration of nitrogen content of a treated surface.

FIGS. 6, 7, 8, 9, 10 and 11 include illustrations of exemplary apparatuses to treat components.

FIG. 12 includes a flow chart to illustrate an exemplary method to maintain a mechanical system.

### DESCRIPTION OF THE DRAWINGS

In a particular embodiment, a component of a mechanical system includes a first region formed of a metallic material and having a first functionally gradient surface treatment depth. The component also includes a second region formed of the metallic material and having a second functionally gradient surface treatment depth. The first functionally gradient surface treatment depth is at least 30% greater than the second functionally gradient surface treatment depth. In an exemplary embodiment, the second functionally gradient surface treatment depth is not greater than about 20 micrometers. In an example, the first region corresponds with a region exposed to high wear and erosive environments, while the second region corresponds with a region exposed to less severe environments. For example, the first region may correspond with a tip of a compressor blade or the outwardly radial end of a tooth on a gear and the second region may correspond with other regions of the respective compressor blade or gear. In particular, the functionally gradient surface is a surface treated with implanted elemental species in which the concentration of such implanted elemental species decreases in a gradient with depth from the surface. In contrast, a coating typically has an abrupt change in both composition and mechanical properties at the interface between the coating and the metallic material of the component.

In another exemplary embodiment, an apparatus for treating components of mechanical systems includes a vacuum chamber configured to receive a backfill gas, a support to receive a work piece, a filament located within the vacuum chamber and an anode located within the vacuum chamber. The support is located within the vacuum chamber and may be electrically isolated from the anode. In particular, the anode and filament are located relative to each other within the chamber to increase electron density around a portion of the work piece. In addition, the filament is negatively electrically biased relative to the anode. The apparatus may further include voltage sources operable to electrically bias the work piece, the filament and the anode relative to each other or relative to electrical ground. In a particular example, the vacuum chamber is electrically grounded.

Particular components within a mechanical system may experience increased wear relative to other components within the mechanical system. In addition, specific regions of the component may experience greater wear and greater exposure to an erodent, such as a particulate material, than other regions of the component.

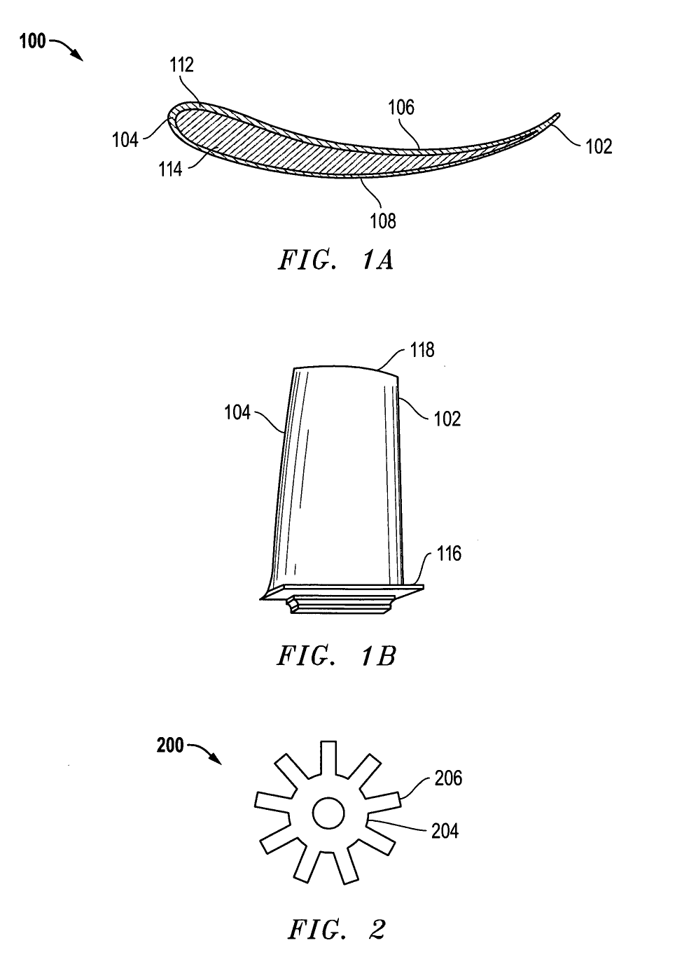

FIGS. 1A and 1B include illustrations of an exemplary compressor blade 100. FIG. 1A includes a cross-sectional view illustration of the exemplary compressor blade 100 and FIG. 1B includes a perspective view illustration of the exemplary compressor blade 100. The compressor blade 100 includes a leading edge 104 and a trailing edge 102 relative to the expected flow of gases around the compressor blade 100. In addition, the compressor blade 100 includes a suction side 108 and a pressure side 106 relative to the expected movement of the compressor blade. As illustrated in FIG. 1B, the base 116 of the blade 100 may be configured to couple with a compressor wheel or may be formed as part of a blisk. The tip 118 of the blade 100 extends from the base 116 in a radial direction when coupled to a compressor wheel or when formed as a portion of a blisk. Typically, a set of compressor blades may be attached to a compressor wheel and removed for repair. For example, a compressor wheel may include a rotor disc configured to receive compressor blades with fir tree or dovetail roots. In contrast, a blisk is a bladed rotor disc where the blades are integral to the blisk or are permanently attached. In a typical environment, such as when installed in a turbine engine, the pressure side surface 106 of compressor blade 100 experiences increased exposure to erodent particulate relative to other regions on the compressor blade 100, particularly along the leading edge 104 and on surface 106 near tip 118. In another example, FIG. 2 illustrates an exemplary gear 200 including teeth 206 and valleys 204. Typically, the teeth 206 of the gear 200 experience increased wear relative to the valleys 204.

In a particular example, the component, such as a blade or a gear may have a length ratio. The length ratio is a ratio of the length of the component relative to the thickness of the part. For example, the length ratio may be in a range of 2 to 35, such as 5 to 20. When a component, such as a compressor blade, is attached to a compressor wheel or formed as part of a blisk, the length ratio is determined based on the blade dimensions. When the component is a gear, the length ratio is determined based on the dimensions of the teeth.

Returning to FIG. 1, to improve wear resistance and other properties, the surface of the compressor blade 100 may be treated to form a functionally gradient surface 112 within the material 114 of the compressor blade 100. In an example, the functionally gradient surface 112 is a surface treated with elemental species in which the concentration of implanted elemental species decreases in a gradient with depth from the surface. For example, a functionally gradient surface including nitrogen may be formed using nitrogen plasma and may include nitrogen content that decreases with depth from the surface. In general, the material 114 of the compressor blade 100 is metallic. A metallic material typically includes a transition metal, a Group 13 metal (e.g., Al and In), or any alloy thereof. In an example, the metallic material includes iron. In another example, the metallic material includes titanium. In a further example, the metallic material may include aluminum. In a particular example, a metallic material of a component in a mechanical system may include stainless steel alloys. In an example, the stainless steel includes an austenitic stainless steel. In another example, the stainless steel includes a martensitic stainless steel. In a further example, the stainless steel includes a ferritic stainless steel. In an additional example, the stainless steel includes a precipitation-hardened stainless steel. A particular example of a metallic material includes Hastelloy, Inconel, 17-4PH stainless steel, 304 stainless steel, titanium, Ti-6Al-4V, or any combination thereof. Alternatively, materials used in a component may include ceramic materials formed from metals or semi-metals.

In an exemplary embodiment, the functionally gradient surface is formed as a result of elemental species implantation within a component material. For example, the functionally gradient surface may be formed through a plasma treatment using a reactive gas. A reactive gas may include an organic gas, nitrogen, boron, or any combination thereof. An organic gas may include an aliphatic organic gas, such as methane, ethane, propane, or any combination thereof. In addition, the plasma may include an inert gas, such as argon. An exemplary treatment includes plasma nitriding in which a component is exposed to a plasma including nitrogen.

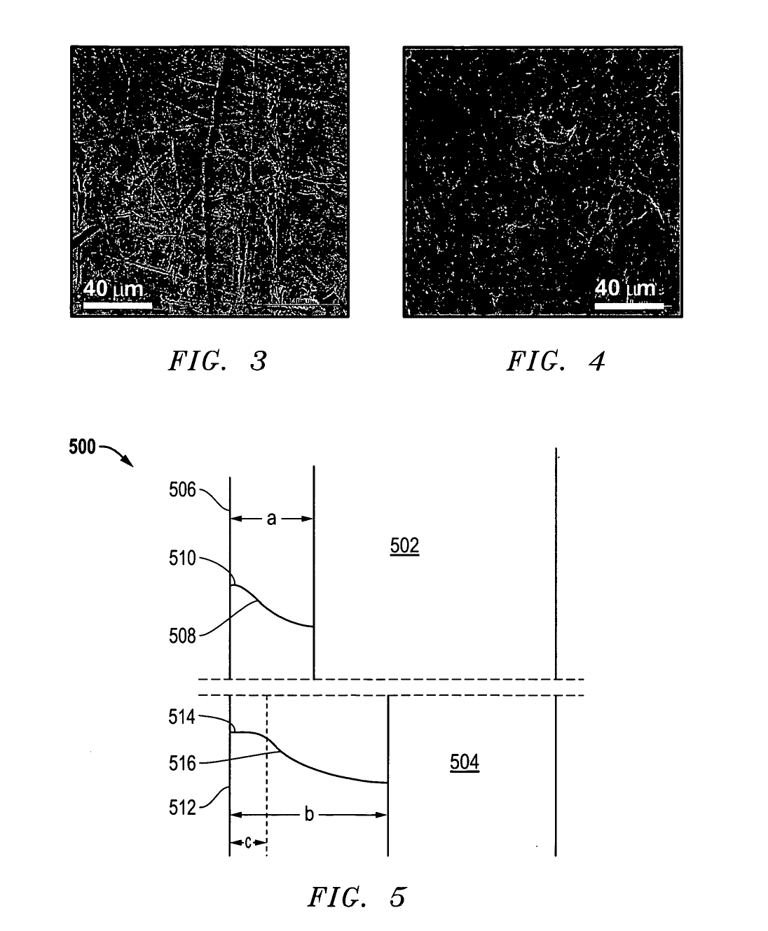

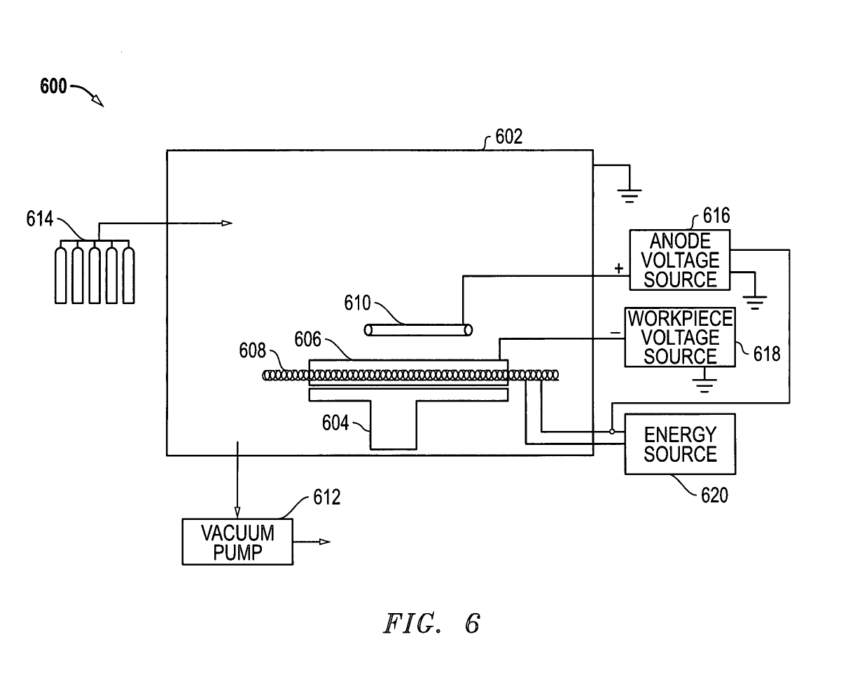

Typically, elemental species of a reactive gas are embedded in the component material surface forming a concentration gradient that decreases with depth from the surface into the component materials. For example, FIGS. 3 and 4 include illustrations of a surface formed from 17-4PH stainless steel before and after nitriding treatment, respectively. As illustrated in FIG. 4, the plasma nitride treated surface exhibits a smooth and frosted appearance relative to the untreated surface illustrated in FIG. 3. Below the treated surface, the concentration of nitrogen within the material decreases as a f unction of depth from the surface.

FIG. 5 includes an illustration of an exemplary component 500 including surface regions 502 and 504. In an example, the concentration of implanted elemental species as depicted by line 508 decreases from a surface concentration at 510 at surface 506 to less than an effective amount at treatment depth ‘a’ from the surface 506. The treatment depth is the depth beyond which the concentration of implanted elemental species decreases below an effective amount. An effective amount is an amount effective to increase microhardness or that undergoes work hardening in response to particle impact. While the effective amount may be different for different materials and with different elemental species, an effective amount is generally at least about 0.2 wt %, such as at least about 0.5 wt %. In particular, an effective amount of nitrogen in stainless steel is at least about 0.2 wt %. In a separate region 504, the implanted elemental species may decrease from a surface concentration at 514 near the surface 512 to below an effective amount below a treatment depth ‘b’ from the surface 512. In an exemplary embodiment, the functionally gradient surface treatment depth ‘b’ is greater than the functionally gradient surface treatment depth ‘a’. For example, the treatment depth ‘b’ may be at least 30% greater than the treatment depth ‘a’, such as at least 40% greater or at least 50% greater. Typically, the treatment depths are not greater than 100 micrometers. In a particular embodiment, treatment depth ‘b’ is at least 20 micrometers and the treatment depth ‘a’ is not greater than 20 micrometers. In another example, the treatment depth ‘b’ is at least 25 micrometers, such as at least 30 micrometers or at least 40 micrometers. In a further example, the treatment depth ‘a’ is not greater than 15 micrometers, such as not greater than 10 micrometers.

Such a difference in functionally gradient surface treatment depths may be achieved by differences in the environment around the regions of a component and temperatures of the regions themselves during treatment. In particular, the region 504 may experience an increased exposure to bombarding electrons and positive ions, resulting in a higher concentration, as indicated at 514, that extends to a further treatment depth within the surface 512. In particular, the concentration may plateau at 514 for a distance ‘c’ from the surface 512 and gradually taper off in a gradient 516 until reaching a treatment depth ‘b’ from the surface 512.

In particular, the gradient profile leading from a surface into a component may be influenced by various factors, such as the environment surrounding the region of the component and the temperature of the region itself. Further, such factors may be interdependent. For example, the temperature of a region is a function of ion bombardment from the plasma environment about that region. An exemplary environmental factor that may influence the treatment of a surface includes pressure of a plasma surrounding the surface, radiant energy impinging on a surface, electron cloud density and ion density around a surface region, or any combination thereof. In addition, the surface treatment may be influenced by a temperature of a region in addition to the charge of that region relative to other components of the system. In general, components undergoing treatment are electrically grounded or are electrically biased to form a cathode relative to other components of the system.

Component treatment may be performed using an apparatus, such as the apparatus 600 illustrated in FIG. 6. The apparatus 600 includes a vacuum chamber 602 housing a support 604 for supporting or receiving a work piece 606. In addition, an electrode 610 and an emission source 608 may be housed within the vacuum chamber 602. The vacuum chamber 602 is configured for vacuum level pressures. In an example, a vacuum pump 612 may create a vacuum within the chamber 602. For example, the vacuum may be at an absolute pressure between 0.01 millibar to 1.0 millibar, such as 0.02 millibar to 0.1 millibar. In addition, the chamber 602 may be backfilled with a gas, such as a reactive gas or a mixture of gases, such as a mixture of an inert gas and a reactive gas. In an exemplary embodiment, the gas 614 includes nitrogen. In another exemplary embodiment, the gas 614 includes a gaseous organic compound, such as an aliphatic organic gas. In a further example, the gas may include boron. In a particular example, the gas includes a mixture of nitrogen and argon. For example, the gas may include a mixture of argon and nitrogen in a compositional ratio in a range of 99:1 nitrogen/argon to 1:9 nitrogen/argon, such as a range of 2:1 nitrogen to 5:1 nitrogen/argon based on volume.

In an exemplary embodiment, the chamber 602 may be used at room temperature. Alternatively, the chamber 602 may be heated by external heaters (not shown). As illustrated in FIG. 6, the chamber 602 is electrically grounded. Alternatively, the chamber 602 may be biased positively or negatively relative to ground or relative to the electrode 610.

An emission source 608 may be configured to enhance plasma production within the chamber 602. As illustrated, the emission source 608 includes a filament attached to an energy source 620. The energy source 620 may energize the emission source 608, for example, to heat the emission source 608. For example, the filament may be formed of a metal or ceramic material, which, during operation, is heated to a temperature not greater than a vaporization temperature of the material. Heating to a temperature greater than a vaporization temperature may result in undesirable deposition of filament material on the electrode 610, the vacuum chamber 602, or the work piece 606. Alternatively, the emission source 608 may include a radio frequency plasma generator. In general, the emission source 608 is negatively biased relative to the electrode 610 or relative to ground. For example, the electrode 610 may be attached to a voltage source 616 that positively biases the electrode 610 relative to ground or relative to the emission source 608. As such, the electrode 610 forms an anode. In a particular example, the emission source 608 is negatively electrically biased relative to the electrode 610 by at least 80 volts, such as at least 100 volts.

In an exemplary embodiment, the work piece 606 has a negative electrical bias relative to the electrode 610. For example, the work piece 606 may be connected to a voltage source 618 producing a negative electrical bias relative to ground or relative to the electrode 610. In a particular example, the work piece 606 may be negatively electrically biased relative to the electrode 610 by at least 850 volts, such as at least 1000 volts. Alternatively, the work piece 606 may be negatively electrically biased relative to the electrode 610 by grounding the work piece 606. When so biased, positive ions within the plasma may be attracted to and may accelerate toward the work piece 606.

While the voltage control between the components of the system 606, 608 and 610 is illustrated as being controlled by a set of voltage and energy sources 616, 618 and 620, various configurations of voltage and energy sources may be envisaged for producing the relative voltages between the components 606, 608 and 610. Optionally, the support 604 may be grounded or electrically isolated from the work piece 606. In another embodiment, the support 604 may be electrically isolated from the vacuum chamber 602.

As illustrated, the emission source 608 includes a filament ring around the work piece 606. In addition, the electrode 610 may be formed as a circular ring located above the work piece. In a particular embodiment, the emission source 608 and the electrode 610 may be concentric with a circular work piece 606. Alternatively, the emission source 608 or the electrode 610 may be formed in a shape that influences the plasma density, including the electron density and the positive ion density, near a particular region of the work piece 606 relative to other regions of the work piece 606. In general, the emission source 608 and the electrode 610 are located relative to each other within the chamber 602 such that electrons passing between the emission source 608 and the electrode 610 contact a portion of the work piece 606 with greater frequency relative to the rest of the work piece 606. For example, when the work piece 606 is a set of compressor blades radially extending from a center, the tips of the blades may experience increased bombardment by electrons and positive ions influenced by the emission source 608 relative to other regions of the work piece. In another example, a gear including teeth that extend radially from a center of the gear may experience a higher concentration of plasma ions and electrons than valleys and center portions of the gear.

In operation, radiative heat from the emission source 608, energy imparted by ion impact, and optionally, heating from the chamber 602 or direct heating or cooling of the work piece 606 itself influence the surface temperature of regions of the work piece 606. For example, the temperature of the surface of the work piece 606 may be in a range between 350° C. and 650° C. The system 600 may also include a controller (not shown) to control variables, such as voltages, filament temperature, chamber temperature, pressure, or coolant rates.

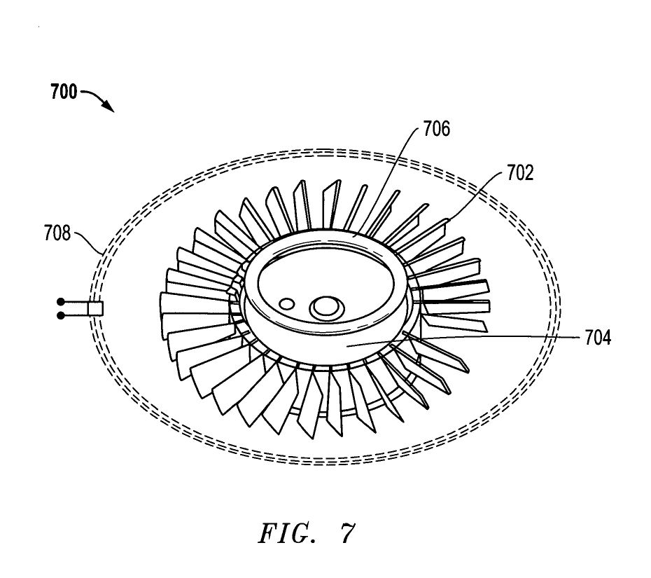

FIG. 7 includes an illustration of an exemplary arrangement 700 of components relative to a work piece 702. The arrangement 700 includes an anode 706 in the form of a circular ring over a center portion of the work piece 702. A filament emission source 708 surrounds a radius of the circular work piece 702 at an axial location. In addition, a shadow plate 704 may be situated between the work piece 702 and the anode 706.

In general, the work piece 702 and filament emission source 708 are negatively electrically biased relative to the anode 706. Typically, the filament emission source 708 has a smaller negative electrical bias relative to the anode 706 than the work piece 702. For example, the work piece 702 may have a negative electrical bias relative to the filament emission source 708. Alternatively, the work piece 702 may have a smaller negative electrical bias relative to the anode 706 than the filament emission source 708.

In general, plasma enhanced by the filament emission source 708 results in greater exposure of the work piece 702 at radially outward portions of the work piece 702. The shadow plate 704 further inhibits exposure of center portions of the work piece 702 to plasma electrons and ions.

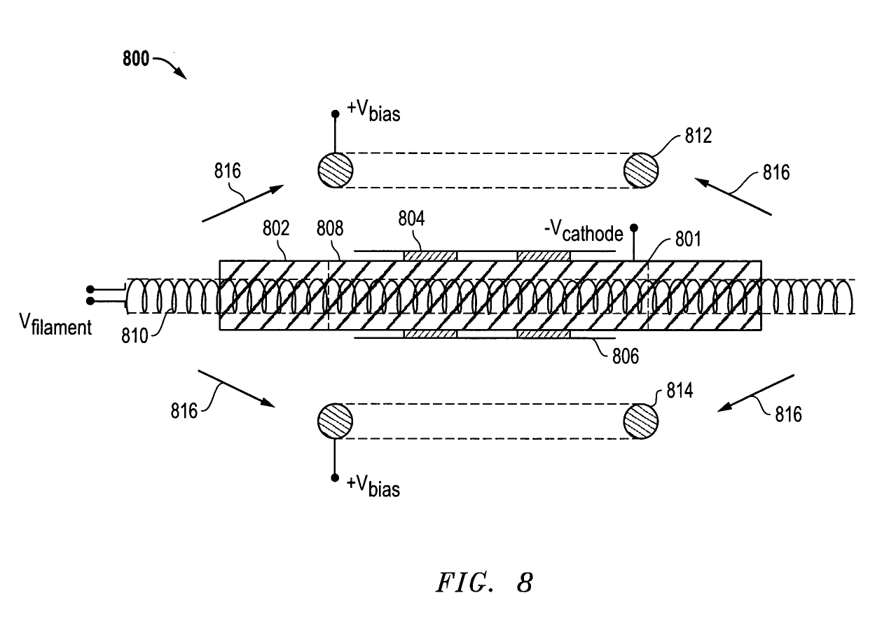

FIG. 8 includes a further exemplary embodiment of a treatment system 800. A work piece 801 may include a radially outermost portion 802 and a radially innermost portion 808. As illustrated, the radially innermost portion 808 is shadowed by shadow plates 804 and 806 on axially opposite sides of the radially innermost portion 808. In addition, electrodes 812 and 814 are axially spaced above and below the work piece 801, respectively. Further a filament emission source 810 extends around a radius of the work piece 801 at an axial location of the work piece 801.

In operation, the filament emission source 810 may be heated to enhance a plasma. For example, the filament emission source 810 may be heated to a temperature not greater than a vaporization temperature of material forming the filament emission source 810. In an exemplary embodiment, the filament emission source 810 is heated to about 2000° C. The electrodes 812 and 814 are positively electrically biased relative to the filament emission source 810. In addition, the work piece 801 may be negatively electrically biased relative to the electrodes 812 and 814. As such, electrons are attracted from the filament emission source 810 towards the positively biased electrodes 812 and 814 located axially above and below the work piece 801. Energizing the plasma near the radially outermost portion 802 of the work piece 801 is believed to increase the treatment and as a result, the treatment depth at the radially outermost region 802 relative to the radially innermost region 808 is increased.

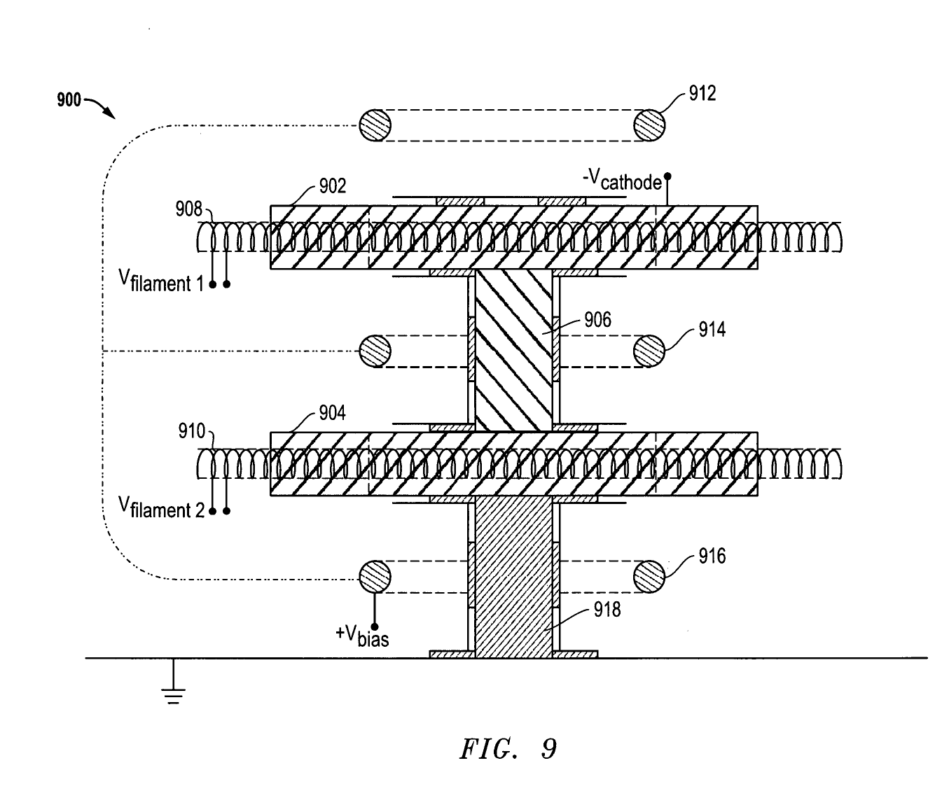

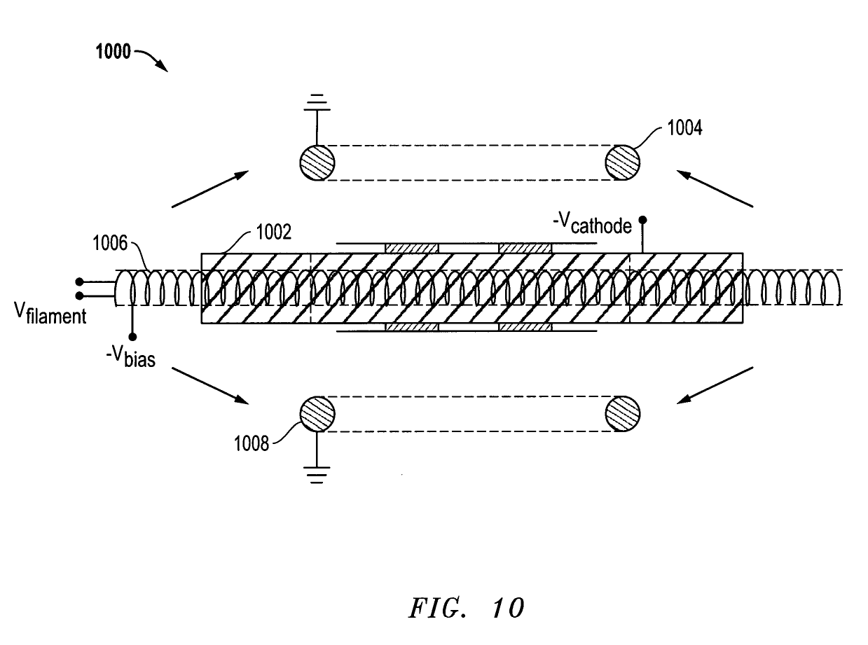

FIG. 9 includes an illustration of an alternative embodiment 900 for treating at least two work pieces 902 and 904. In such an exemplary embodiment, the work pieces 902 and 904 are separated by a support 918 that includes a conductive portion 906 providing an electrically conductive path between the work piece 902 and the work piece 904. An electrode 912 is located axially above the work piece 902, an electrode 914 is located axially between the work piece 902 and the work piece 904, and an electrode 916 is located axially below the work piece 904. As illustrated, the electrodes 912, 914 and 916 are in the form of annular rings. In an exemplary embodiment, the electrodes 912, 914, and 916 are concentric with the work pieces 902 and 904. Alternatively, the electrode 912 may be in the form of a ball located such that an axis extending through the work pieces 902 and 904 intersects the ball. In another alternative embodiment, the electrodes 912, 914 and 916 form concentric rings of different radii that may be concentric with the work pieces 902 and 904 or alternatively, may have center points offset from the axis extending through the work pieces 902 and 904.

In addition, the exemplary system 900 includes filaments 908 and 910. As illustrated, filament 908 annularly surrounds the work piece 902 at an axial location of the work piece 902 and filament 910 annularly surrounds work piece 904 at an axially location of the work piece 904. The work pieces 902 and 904 and the filaments 908 and 910 may be negatively electrically biased relative to the electrodes 912, 914 and 916. As illustrated, the work pieces 902 and 904 are provided with the same electrical bias. Alternatively, the work pieces 904 and 902 may be electrically isolated from each other and provided with different negative electrical biases. The filaments 908 and 910 may have the same negative electrical bias relative to the electrodes 912, 914 and 916. Alternatively, the filaments 908 and 910 may be provided with different negative biases relative to the electrodes 912, 914 and 916. In addition, the electrodes 912, 914 and 916 may be provided with the same positive electrical bias relative to the other components or relative to electrical ground. Alternatively, each of the electrodes 912, 914 and 916 may be provided with different electrical biases relative to ground or relative to the other components of the system. A plasma enhanced by the filaments 908 and 910 may have a higher density near an outermost portion of the work pieces 902 and 904 when attracted to the electrodes 912, 914 and 916 acting as anodes.

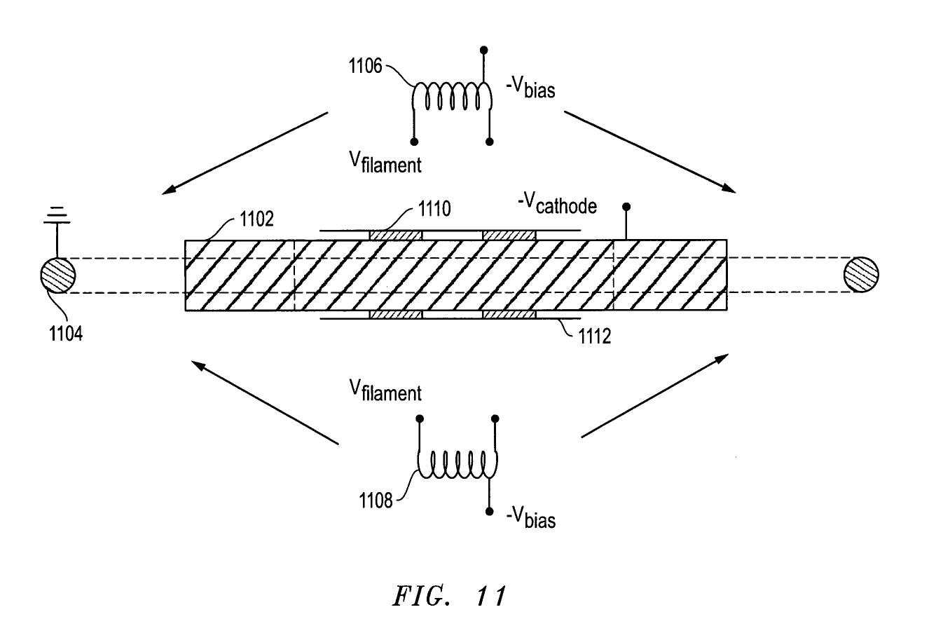

An alternative embodiment is illustrated in FIG. 10 in which a system 1000 includes a work piece 1002 having a negative bias relative to electrodes 1004 and 1008. As illustrated the electrodes 1004 and 1008 are electrically grounded. In such an embodiment, the work piece 1002 may be connected to a voltage source providing a negative voltage bias relative to ground. Similarly, a filament emission source 1006 may be negatively biased relative to ground and thus, relative to the electrodes 1004 and 1008.

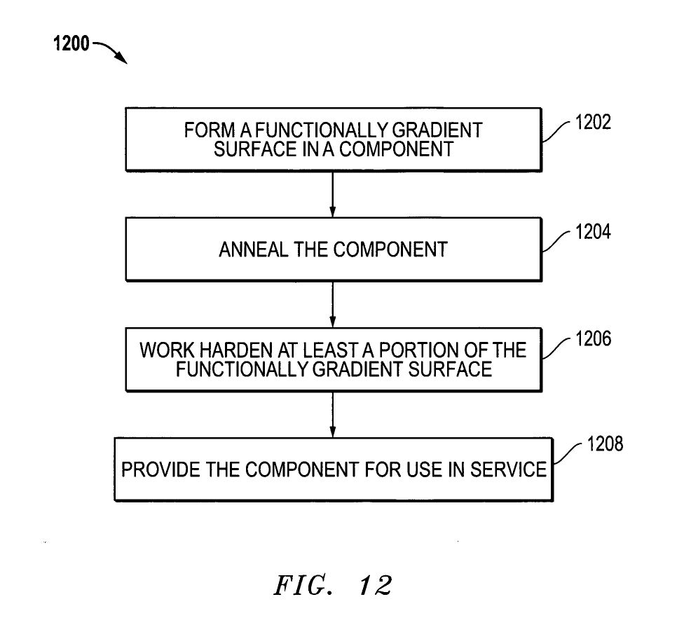

In a further alternative embodiment illustrated in FIG. 11, filament emission sources 1106 and 1108 may be located axially above and below the work piece 1102. Such exemplary emission sources 1106 and 1108 may be in the form of rings concentrically located with the work piece 1102. Alternatively, the filament emission sources 1106 and 1108 may have a shape, such as a line or a cross. A grounded electrode 1104 may form a ring annularly surrounding the work piece 1102 at an axial location of the work piece 1102. Further, the system may include shadow plates 1110 and 1112 overlying a center portion of the work piece 1102. In operation, the plasma influenced by the filament emission sources 1106 and 1108 may be drawn toward electrode 1104 and may have a greater density near the radially outermost portions of the work piece 1102.

Using the above-illustrated exemplary systems, a work piece exposed to treatment conditions may have an increased functionally gradient surface treatment depth at a first location and reduced functionally gradient surface treatment depth at a second location. As such, deeper reactive treatments may be provided to different regions of the work piece in anticipation of different mechanical stresses, wear, and other environmental hazards experienced by particular portions of the work piece. For example, a compressor blade may be treated to have a greater treatment depth near the tip of the compressor blade to improve erosion resistance when exposed to high velocity particulate erodents. However, increased treatment depths may adversely affect fatigue life and corrosion resistance. As such, other portions of the compressor blade may undergo reduced treatment and thus, limit reductions in fatigue life and limit increases in corrosion susceptibility.

In a particular embodiment, a treated component exhibits a fatigue life comparable with an untreated component. Fatigue life may be tested by applying a particular stress to a component in cycles and determining how many cycles the component undergoes before failure. The number of cycles is interpreted as the fatigue life at the particular stress. Generally, the fatigue life increases with a decrease in applied stress. To quantify the response of fatigue life to a decrease in fatigue stress, a fatigue parameter is defined herein as a percent decrease in the applied stress that extends the average fatigue life of a component from 1.0×10⁴ cycles to 1.0×10⁷ cycles. For example, a set of components may be tested to determine an average failure stress that results in a fatigue life of about 1.0×10⁴ cycles. A second identical set of components may be tested to determine an average failure stress that results in a fatigue life of at least 1.0×10⁷ cycles. The fatigue parameter is the percent difference between the average failure stress resulting in a fatigue life of 1.0×10⁴ cycles and the average failure stress resulting in a fatigue life of at least 1.0×10⁷ cycles with respect to average failure stress resulting in the fatigue life of 1.0×10⁴ cycle. In a particular example, the treated components have a fatigue parameter not greater than about 20%, such as not greater than about 15%.

In an example, a 17-4 PH stainless steel T56 2^{nd} stage compressor blade is treated in nitrogen plasma to form different surface treatment depths in different sections. Section 1 is located nearer the tip of the blade than Section 2. Section 2 is located near the middle of the blade and Section 3 is located near the base of the blade. For example, Section 1 exhibits a nitrogen content at the surface of about 23 atomic %, which decreases over 5 micrometers to 10 atomic %, and has a functionally gradient surface to a treatment depth of about 54 micrometers. In another example, Section 2 exhibits a surface nitrogen content of about 15 atomic % to about 16 atomic % and has a functionally gradient surface to a treatment depth of about 19 micrometers. In a further example, Section 3 exhibits a surface nitrogen content of about 15 atomic % to about 16 atomic % nitrogen with a functionally gradient surface treatment depth of about 4 micrometers. Nitrogen content of the component may be determined by, for example, Scanning Electron Microscopy/Energy Dispersive Spectrometry analysis.

In another example, a 17-4 PH stainless steel T56 2^{nd} stage compressor blade is treated in nitrogen plasma to form different surface treatment depths in different regions. Regions 1, 2, and 3 are located on the pressure side of the blade near the tip of the blade. Region 1 is located near the trailing edge of the blade, Region 2 is located in the middle of the blade, and Region 3 is located near the leading edge of the blade. Each region exhibits a different microhardness profile based at least in part on the treatment depth. For example, Region 1 has a surface treatment depth of at least 60 micrometers. Region 2 has a treatment depth of at least 47 micrometers and Region 3 has a surface treatment depth of at least 50 micrometers. The micro hardness HV50 for the regions at 40 micrometers from the surface is about 1490 for Region 1, about 430 for Region 2, and about 820 for Region 3. Each region exhibits a plateau of microhardness HV50 of about 380 at depths greater than the treatment depth. The microhardness HV50 plateaus at about 380 at about 45 micrometers for Region 2, at about 50 micrometers for Region 3, and about 64 micrometers for Region 1.

In a further example, 17-4 PH stainless steel T56 2^{nd} stage compressor blades are tested for erosion resistance. A set of sample blades is treated in a nitrogen plasma to form a functionally gradient surface having a treatment depth at least about 40 micrometers. A set of comparative samples is treated with a titanium nitride surface coating. A G76 erosion test is conducted using 50-micrometer alumina erodent in an air stream of 83 meters/second at an impingement angle of 90 degrees and at ambient lab temperature. The initial erosion weight loss for the nitride treated sample blades is 0.172 mg/gram of erodent, higher than the initial erosion rate of the comparative samples (0.107 mg/gram of erodent). However, the nitride treated sample blades exhibit a plateau at which the rate of erosion drops below the erosion rate of the titanium nitride coated comparative samples. For example, at a cumulative weight of 20 grams of erodent, the nitride treated samples have an erosion rate of 0.12 mg/g and the titanium nitride coated samples have an erosion rate of 0.23 mg/g. As indicated, the surface of a functionally treated component may undergo work hardening, resulting in a reduced erosion rate with increased exposure to erodent. Further, use of particulate in an air stream having a velocity at least about 200 meters/second, such as at least about 250 meter/second or as high as 300 meters/second or higher, may further improve work hardening of a functionally gradient surface.

In an additional example, formation of functionally gradient surfaces to a moderate treatment depth has little affect on fatigue life. For example, a 17-4 PH stainless steel T56 2^{nd} stage compressor blade is provided with functionally gradient surfaces having treatment depths of 3 micrometers, 6 micrometers, and 50 micrometers. The treated sample blades are compared with an untreated blade. After 1.0×10⁷ cycles, the 3-micrometer and 6-micrometer blades exhibit a fatigue parameter of less than 1% (a fatigue stress of about 138 ksi). In contrast, an untreated blade exhibits a fatigue parameter of at least about 14% (a fatigue stress of ˜110 ksi) relative to the initial stress (˜148 ksi) determined after the first 1.0×10⁴ cycles. The 50-micrometer sample fails at less than 1.0×10⁵ cycles with a decrease in stress of about 15%.

Qualitatively, shallow treatment depths provide acceptable corrosion resistance. For example, corrosion may be tested by exposing samples to a salt water bath at an elevated temperature. Moderate treatment depths and the associated treatment conditions appear to provide acceptable corrosion resistance. However, deep treatment depths and the associated treatment conditions appear to result in cracks near the surface that may accelerate corrosion.

Particular embodiments of a component having functionally gradient treatment surfaces exhibit advantageous properties over untreated components or coated components. For example, components having a functionally gradient surface treatment exhibit a particle impact induced work hardening, resulting in a reduced overall erosion rate. Functionally gradient surfaces tend be integral with the substrate material and do not spall or flake like coated treatments.

Particular embodiments of treatment methods and apparatuses for performing such treatment methods advantageously exhibit improvements over traditional coatings and nitriding methods. For example, nitrogen based treatments utilize argon and nitrogen gas and electricity, providing a treatment with low environmental impact. Further, such treatments have less impact on component dimensions and may be lower in cost than coating treatments. In addition, such methods and apparatuses are useful in treating net-shape parts, such as a compressor blade.

In a particular embodiment, the treatment to form a functionally gradient surface in a component followed by high velocity particulate impact of portions of the functionally gradient surface may result in an improved, hardened surface on the component or work piece. Such a technique may be applied to new components prior to service within a mechanical system. Alternatively, such a technique may be used to treat and repair used components, improving and extending useful life. For example, FIG. 12 includes an illustration of an exemplary method for maintaining a mechanical system. The method 1200 includes forming a functionally gradient surface in a component of the mechanical system, as illustrated at 1202. For example, a metallic component may be treated using an enhanced plasma nitriding system to form a functionally gradient surface including a gradient of nitrogen content. In a particular example, the functionally gradient surface has a treatment depth defined as a depth from the surface below which the average nitrogen content is less than 0.2 wt %. Alternatively, a component may be boronized, carbonized or otherwise ion treated to form the functionally gradient surface. In a particular embodiment, the component may be exposed to both nitrogen ions and carbon ions resulting in a nitridized and carbonized component.

Depending on the configuration of the treatment system and the environment in which the component is treated, different portions of the component or work piece may be exposed to different plasma density. In particular, portions of the component may undergo greater exposure to the treatment, resulting in greater treatment depths than other regions of the component. In an exemplary embodiment, a region of the component includes a functionally gradient surface having a treatment depth of at least 5 micrometers, such as illustrative depths of at least 10 micrometers, at least 20 micrometers, or at least 30 micrometers, or higher.

In an exemplary embodiment, the component may be annealed, as illustrated at 1204. For example, a component may be heated at an annealing temperature for a period of time. Such annealing temperatures and times may be a function of component metallurgy. In a particular example, the component is annealed at a temperature in a range between 350° C. and 650° C. for a time period in the range of 1 hour to 18 hours. For example, a stainless steel article may be annealed at a temperature in a range between 350° C. and 450° C. for a time period in a range between 1 hour and 15 hours. In another example, a titanium alloy article may be annealed at a temperature in a range between 450° C. and 620° C. for a time period in a range between 1 hours and 15 hours. In an exemplary embodiment, annealing may reduce surface concentration of the elemental species, such as nitrogen. High surface concentrations of nitrogen tend to exhibit brittle behavior and increased erosion when subjected to particle impacts. Lower surface concentrations of nitrogen exhibit improved erosion resistance when subjected to particle impacts. In a particular example, nitrogen plasma treated 17-4 PH stainless steel samples have a high rate of erosion with about 5.0 wt % to 8.0 wt % surface nitrogen content. After sand erosion has removed the high nitrogen portion of the surface, the same samples with about 0.5 wt % to 3.0 wt % surface nitrogen content have improved erosion resistance. In this example, an annealing process may diffuse the nitrogen deeper into the treated component, reducing the surface nitrogen content and providing a deeper gradient surface with lower overall nitrogen content. The post-anneal treated gradient surface may exhibit improved erosion resistance throughout the treated depth. In a particular embodiment, the component is nitrogen plasma treated and annealed to form a surface in particular regions having a desirable surface concentration. For example, the surface may have a surface concentration of an implanted elemental species not greater than 8.0 wt %, such as not greater than 5.0 wt % or not greater than 3.0 wt %, wherein the functionally gradient portion has a nitrogen content between about 0.5 wt % and 3.0 wt % to an effective depth of at least about 20 micrometers, such as at least about 30 micrometers. In other regions, such as regions that experience less erosion, the functionally gradient surface may have a treatment depth not greater than about 25 micrometers, such as not greater than 20 micrometers. Alternatively, the component may have a functionally gradient surface having a uniform treatment depth

Once the functionally gradient surface has been formed in the component of the mechanical system and optionally, the component has been annealed, portions or all of the component or part may be work hardened, as illustrated at 1206. In particular, the treated portions of the component or all of the component may be exposed to high velocity particulate impact via a shot peening process, or erosion using a high velocity erodent particulate. For example, the portions may be exposed to a shot peeing treatment. Alternatively, the portions may be exposed to a stream of air having impact particulate and having a velocity of at least about 100 meters per second. In a particular example, the velocity of the air is at least about 200 meters per second, such as at least about 250 meters per second, or as high as 300 meters/second or higher. In an exemplary embodiment, the impact particulate is an erodent particulate.

In particular, impact particulate having a rounded shape and large particle size has shown to improve work hardening of a functionally gradient surface. For example, the particulate material may have an average particle size of at least 25 micrometers, such as at least 40 micrometers or at least 50 micrometers. In a further example, the particulate material may have an average particle size of at least about 100 micrometers, such as at least 150 micrometers or as high as 200 micrometers or higher. An exemplary impact particulate includes alumina, silica, or any combination thereof. In another example, the impact particulate is metallic, ceramic, or any combination thereof. In a particular example, the particulate material includes a coarse particulate, such as an A4 Arizona road sand. Alternatively, the particulate erodent may include a 50-micrometer alumina particulate. In a further example, the impact particulate includes shot having an average diameter of at least about 500 micrometers.

Upon exposure to particulate impact, the component exhibits improved surface hardness and resistance to further erosion. In addition, the component may exhibit improved corrosion resistance and fatigue resistance following exposure to particulate impact. In an alternative embodiment, the component may be annealed subsequent to work hardening. As such, the part or component of the mechanical system may be provided for use in service, as illustrated at 1208.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A treatment apparatus comprising:
a vacuum chamber to receive a backfill gas;
a support to receive a work piece, the support located within the vacuum chamber;
a filament located within the vacuum chamber; and
an anode located within the vacuum chamber.

2. The treatment apparatus of claim 1, wherein the anode and the filament are located relative to each other within the chamber to provide a greater electron density around a portion of the work piece relative to another portion of the work piece.

3. The treatment apparatus of claim 2, wherein the work piece has a length ratio of at least 2 to 35.

4. The treatment apparatus of claim 2, wherein the work piece includes a set of compressor blades extending radially and wherein the anode and the filament form annular rings and are located relative to each other to produce a greater electron density at a radially outermost portion of each of the set of compressor blades relative to a radially inward portion of each of the set of compressor blades.

5. The treatment apparatus of claim 4, wherein the work piece comprises a compressor wheel with the set of compressor blades.

6. The treatment apparatus of claim 4, wherein the work piece comprises a blisk.

7. The treatment apparatus of claim 1, further comprising a voltage source configured to negatively electrically bias the work piece relative to the anode.

8. The treatment apparatus of claim 7, wherein the work piece forms a cathode.

9. The treatment apparatus of claim 7, wherein the voltage source is configured to negatively electrically bias the work piece relative to the anode by at least 850 volts.

10. The treatment apparatus of claim 9, wherein the voltage source is configured to negatively electrically bias the work piece relative to the anode by at least 1000 volts.

11. The treatment apparatus of claim 1, further comprising a connector configured to electrically ground the work piece.

12. The treatment apparatus of claim 1, further comprising a voltage source configured to negatively bias the filament relative to the anode.

13. The treatment apparatus of claim 12, wherein the voltage source is configured to negatively electrically bias the filament relative to the anode by at least 80 volts.

14. The treatment apparatus of claim 13, wherein the voltage source is configured to negatively electrically bias the filament relative to the anode by at least 100 volts.

15. The treatment apparatus of claim 1, further comprising an electrical source configured to energize the filament.

16. The treatment apparatus of claim 1, wherein the vacuum chamber is grounded.

17. The treatment apparatus of claim 1, further comprising a second anode.

18. The treatment apparatus of claim 1, further comprising a second filament.

19. The treatment apparatus of claim 1, wherein the anode forms an annular ring.

20. The treatment apparatus of claim 1, wherein the filament forms an annular ring.

21. The treatment apparatus of claim 1, wherein the work piece is metallic.

22. The treatment apparatus of claim 21, wherein the work piece includes a metal alloy.

23. The treatment apparatus of claim 1, wherein the backfill gas comprises nitrogen.

24. A method of treating a component, the method comprising:
locating a work piece within a vacuum chamber, an anode and a filament located within the vacuum chamber;
negatively electrically biasing the work piece relative to the anode; and
heating the filament.

25. The method of claim 24, wherein the anode and the filament are located relative to each other within the vacuum chamber to provide greater electron density around a portion of the work piece relative to another portion of the work piece.

26. The method of claim 24, wherein negatively electrically biasing the work piece includes negatively electrically biasing the work piece by at least 800 volts relative to the anode.

27. The method of claim 26, wherein negatively electrically biasing the work piece includes negatively electrically biasing the work piece by at least 1000 volts relative to the anode.

28. The method of claim 24, wherein negatively electrically biasing the work piece includes electrically grounding the work piece.

29. The method of claim 24, wherein heating the filament includes heating the filament to a temperature not greater than a vaporization temperature of the filament.

30. The method of claim 24, further comprising forming a vacuum within the vacuum chamber relative to ambient conditions and backfilling with a gas.

31. The method of claim 30, wherein forming the vacuum includes creating an absolute pressure of 0.01 millibar to 1.0 millibar within the vacuum chamber.

32. The method of claim 31, wherein forming the vacuum includes creating an absolute pressure of 0.02 millibar to 0.1 millibar within the vacuum chamber.

33. The method of claim 30, wherein the gas is reactive.

34. The method of claim 33, wherein the gas comprises nitrogen.

35. The method of claim 33, wherein the gas comprises an organic component.

36. The method of claim 35, wherein the organic component comprises an aliphatic organic gas.

37. The method of claim 33, wherein the gas comprises boron.

38. The method of claim 30, wherein the gas comprises argon.

39. The method of claim 24, wherein the work piece is metallic.

40. A component comprising:
a first region formed of a metallic material and having a first functionally gradient surface treatment depth; and
a second region formed of the metallic material and having a second functionally gradient surface treatment depth, the first functionally gradient surface treatment depth being at least 30% greater than the second functionally gradient surface treatment depth, the second functionally gradient surface treatment depth being not greater than 20 micrometers.

41. The component of claim 40, wherein the first functionally gradient surface treatment depth is at least about 40% greater than the second functionally gradient surface treatment depth.

42. The component of claim 41, wherein the first functionally gradient surface treatment depth is at least 50% greater than the second functionally gradient surface treatment depth.

43. The component of claim 40, wherein the functionally gradient surface treatment depth is the depth above which the concentration of an implanted elemental specie is at least about 0.2 wt %.

44. The component of claim 40, wherein the metallic material includes iron.

45. The component of claim 40, wherein the metallic material includes titanium.

46. The component of claim 40, wherein the metallic material is a metal alloy.

47. The component of claim 46, wherein the metal alloy comprises stainless steel.

48. The component of claim 47, wherein the stainless steel comprises an austenitic stainless steel.

49. The component of claim 47, wherein the stainless steel comprises a martensitic.

50. The component of claim 47, wherein the stainless steel comprises a precipitation hardened stainless steel.

51. The component of claim 47, wherein the stainless steel comprises a ferritic stainless steel.

52. The component of claim 40, wherein the first functionally gradient surface treatment depth is at least 20 micrometers.

53. The component of claim 40, wherein the component exhibits a fatigue parameter not greater than 20%.

54. The component of claim 53, wherein the component exhibits a fatigue parameter not greater than 15%.

55. The component of claim 40, wherein the first and second regions comprise nitrogen within at least the first and second functionally gradient surface treatment depths, respectively.

56. A method of treating a component, the method comprising:
forming a functionally gradient surface in a metallic work piece; and
work hardening a portion of the functionally gradient surface using an impact particulate.

57. The method of claim 56, wherein the functionally gradient surface treatment comprises at least about 0.2 wt % nitrogen.

58. The method of claim 56, wherein work hardening the portion of the functionally gradient surface comprises shot peening.

59. The method of claim 56, wherein work hardening the portion of the functionally gradient surface comprises eroding at least a part of the portion using the impact particulate in an air stream having a velocity of at least 100 m/sec.

60. The method of claim 59, wherein the velocity is at least 200 m/sec.

61. The method of claim 60, wherein the velocity is at least 250 m/sec.

62. The method of claim 59, wherein the impact particulate comprises alumina.

63. The method of claim 59, wherein the impact particulate comprises silica.

64. The method of claim 59, wherein the impact particulate comprises shot.

65. The method of claim 59, wherein the impact particulate have an average particle size of at least 40 micrometers.

66. The method of claim 65, wherein the impact particulate have an average particle size of at least 50 micrometers.

67. The method of claim 66, wherein the impact particulate have an average particle size of at least 100 micrometers.

68. The method of claim 56, wherein the metallic work piece comprises a metal alloy.

69. The method of claim 56, wherein the metallic work piece comprises iron.

70. The method of claim 56, wherein the metallic work piece comprises titanium.

71. The method of claim 56, wherein forming the functionally gradient surface comprises forming a functionally gradient surface having a treatment depth at least 5 micrometers.

72. The method of claim 71, wherein the treatment depth is at least 10 micrometers.

73. The method of claim 72, wherein the treatment depth is at least 20 micrometers.

74. The method of claim 56, wherein forming the functionally gradient surface comprises forming a functionally gradient surface through plasma nitriding.

75. The method of claim 56, further comprising annealing the metallic work piece.

76. The method of claim 75, wherein annealing comprises heating the work piece at between 350° C. and 650° C.

77. The method of claim 76, wherein annealing comprises heating the work piece at between 350° C. and 450° C.

78. The method of claim 76, wherein annealing comprises heating the work piece at between 450 ° C. and 620° C.

79. A method of maintaining a mechanical system, the method comprising:
forming a functionally gradient surface in a component of the mechanical system, the functionally gradient surface comprising at least 0.2 wt % nitrogen; and
work hardening at least a portion of the functionally gradient surface in the component.

80. The method of claim 79, further comprising providing the component for insertion into the mechanical system.

81. The method of claim 79, wherein forming the functionally gradient surface includes exposing the component to a nitrogen plasma.

82. The method of claim 79, wherein work hardening the at least the portion of the functionally gradient surface comprises shot peening.

83. The method of claim 79, wherein work hardening the at least the portion of the functionally gradient surface comprises work-hardening using particulate in an air stream having a velocity of at least 100 m/sec.

84. The method of claim 83, wherein the velocity is at least 200 m/sec.

85. The method of claim 84, wherein the velocity is at least 250 m/sec.

86. The method of claim 83, wherein the particulate has an average particle size of at least 40 micrometers.

87. The method of claim 83, wherein the particulate comprises silica.

88. The method of claim 83, wherein the particulate comprises alumina.

89. The method of claim 79, further comprising annealing the component.

90. The method of claim 89, wherein annealing the component comprises annealing the component prior to work hardening.

91. The method of claim 89, wherein annealing the component comprises annealing the component subsequent to work hardening.
